(19) United States
(12) Patent Application Publication
(10) Pub. No.: US 2012/0273012 A1
(43) Pub. Date: Nov. 1, 2012

(54) System and Method of Cleaning and Sanitizing a Tea Brewing/Dispensing System

(75) Inventor: Barry L. Wilson, Zellwood, FL (US)

(73) Assignee: Safe Chem, Inc.

(21) Appl. No.: 13/452,223

(22) Filed: Apr. 20, 2012

Related U.S. Application Data
(60) Provisional application No. 61/479,568, filed on Apr. 27, 2011.

(51) Int. Cl. B08B 9/027; B08B 3/08

(52) U.S. Cl. 134/36; 134/100.1

(57) ABSTRACT

A technique for cleaning a tea concentrate brewing mechanism including heat exchanger tubing and concentrate receptacles employs a safe and effective aqueous chlorine dioxide solution. A chemical dispensing unit employs a venturi body that mixes a sodium chlorite sanitizer with a weak-acid activator injected into the water flow. Preset water-flow rate metering regulation draws in equal amounts of sanitizer and activator. The chemicals are made up in respective concentrations so that the same volume is required of each one. The cleansing solution may be flowed through the brewing mechanism or sprayed on surfaces to be cleaned.

### BACKGROUND OF THE INVENTION

This invention relates to beverage brewing and dispensing systems, and is more particularly concerned with systems that create brewed tea concentrate locally for hot tea and iced tea drinks, with the concentrate to be mixed with water (and with flavors, syrups, etc.) at the point of sale, for example, at restaurants, coffee shops, and ice cream shoppes. The invention is more particularly concerned with a technique for cleaning the brewing mechanism, heat exchanger tubing, and concentrate receptacles of the beverage brewing and dispensing system, and with a safe and effective chemical composition for carrying out this technique.

A system for brewing tea concentrate is described in Wells published patent application No. US 2011/0008504 A1, and the system described therein may represent the state of the art in that apparatus. This system includes a beverage concentrate brewer and a heat exchanger which recovers some of the heat from the brewed product to increase the temperature of the incoming fresh water. There is a pump for moving the liquid through the system, and one or more receptacles to receive the brewed product and from which the beverage can be dispensed to customers.

Many other systems have also been developed for brewing and dispensing tea-based beverages at or near the point of sale, and these are described or mentioned in the art, e.g., Miller Pub. No. US 2010/0173048; Kirschner Pub. No. US 2010/0034943; Van Hattem Pub. No. US 2009/0252846; Colliver et al. U.S. Pat. No. 8,088,424; Maldanis et al. U.S. Pat. No. 7,858,134; Tobin U.S. Pat. No. 7,182,970; and/or Podlucky et al. U.S. Pat. No. 7,067,168. Each of these includes some source of heated water that is flowed through blending equipment where a tea is infused into it and one or more flavorings or sweeteners are added to form a tea beverage or a tea concentrate. However, none of these includes a cleaning system for cleaning and sanitizing the flow pathways or the beverage or concentrate reservoirs or brewing equipment.

It would be desirable to incorporate an automated sanitizing system to flush the inside of the brewers and heat exchangers as well as the conduits through which the liquids flow. To be effective, such a system has to be simple enough to be carried out by store personnel having little or no training, and also be safe to handle, without compromise of its effectiveness. In this system, sanitizing solution may be pumped through the entire system for cleaning and sanitizing. The system may also be used for manual spraying of surfaces of the brewers and beverage concentrate receptacles. The chemistry of the product cannot affect the flavor of the beverage, but must be effective in cleaning and killing bacteria. Ideally, the cleaning and sanitizing solution should not be harmful to the consumers purchasing the beverage made after a cleaning and sanitizing operation, and accordingly safe food grade and kitchen grade chemicals should be used.

### OBJECTS AND SUMMARY OF THE INVENTION

In order to carry out the objects of providing a safe, effective, and simple to use system for cleaning a tea concentrate brewing and dispensing system or other similar beverage preparation system, the inventor herein has provided a specially designed system for sanitizing food and beverage dispensing equipment.

The system has been designed with careful consideration for the special cleaning and sanitizing challenges found in typical restaurant kitchens. Provision was made for employee safety, simplicity of operation, and compatibility of the cleaning and sanitizing chemicals with the beverage brewing and dispensing equipment.

It is known that effective control is required of micro-organisms which can cause off flavors and product spoilage, and such control is an important object of this invention.

A stabilized chlorine dioxide aqueous solution was chosen as the chemical component of this sanitizing system. This is generated in the system from a sanitizing solution in the form of sodium chlorite aqueous solution in a simple one-gallon jug. This is mixed in the equipment with a weak acid, e.g., citric acid aqueous solution, also packaged in a simple one-gallon jug. The sodium chlorite is a non-hazardous material and the citric acid is also non-hazardous. These are injected in equal parts into a water stream that passes through the system where the resulting chlorine dioxide cleans and sanitizes the equipment.

A chemical dispensing unit mixes the sodium chlorite sanitizer with the activator acid and dilutes this with water. The dispensing unit employs venturi orifices for each of the sanitizer and activator, and the water stream draws each of them in to mix in the stream of water and create the chlorine dioxide. The orifices are in a metering tip that connects to suction tubing. The unit includes a preset water-flow rate metering regulator, so equal amounts of sanitizer and activator are drawn in. The chemicals, i.e., the sanitizer and the activator, are made up in respective concentrations so that the same volume is required of each one. These are each drawn in at the same rate. That is, as the water travels through the system and past the venturi mechanism, it creates a negative pressure that pulls in equal amounts of sanitizer and activator. Because both sanitizer and activator flow at the same rate, there is no safety or chemical reaction problem if the employee puts the chemical containers or jugs on the wrong sides and in the wrong racks.

In a preferred arrangement, the mixer portion includes a mixer venturi body through which the input water flows, and a pair of venturi inlets to which are connected the conduits that lead from the sources of the sanitizer aqueous solution and the activator aqueous solution, respectively, with the mixer portion being adapted to employ a venturi effect to pull the sanitizer solution and the activator solution through the conduits and into the flow of water. The mixer portion is positioned so that said flow of water is downward from its inlet to the outlet conduit. The venturi inlets are positioned directly opposite one another on the mixer body, and a control valve is positioned between the water inlet and the upper end of the mixer portion venturi body. Alternatively, the venturi inlets can be aligned in the flow direction, or in other configurations. A removable cover is positioned over the venturi body and attached hardware pieces.

In a preferred arrangement, a water supply connection uses a standard ¾ inch female water hose connection. Stainless steel jug racks hold the sanitizer and activator acid containers. The unit can be wall mounted at or near the location of the beverage concentrate brewing equipment. An outlet side of the cleaning reservoir or empty tea concentrate reservoir can connect with the tea lines where the solution is pumped to flow the chemical through for cleaning and sanitizing. In addition, a ½ inch clear discharge hose is present, and may be used with a spray nozzle for spraying chlorine dioxide solutions of 50 ppm to 200 ppm onto surfaces, or within containers or receptacles. The spray nozzles create a modified fan spray pattern at a discharge rate of e.g., 1.5 gallons per minute. The sanitizer and acid activator diluted solution strength can be easily checked using a customized dual test strip. The activator and sanitizer jugs may be formed of a plastic synthetic resin material, e.g., polyethylene, and with a cap closure being removably fitted onto a neck of the jug. The flexible hose conduits each include a flexible suction tube passing through a penetration in the cap of a respective one of the jugs. To facilitate loading and use by store employees, the jug racks and chemical dispensing covers are well marked for sanitizer and activator. The caps or jar covers can also be color coded to match the jugs. The unit may be wall mounted, installed using four screws and anchors, and taking up minimal wall space.

### BRIEF DESCRIPTION OF THE DRAWING

The invention will be better understood from a description of a preferred embodiment, which will be discussed in connection with the accompanying Drawing.

FIG. 1 shows a wall mounted cleaning and sanitizing system of an embodiment of the present invention, and an associated tea brewing station.

FIG. 2 is an enlargement of the cleaning and sanitizing system of this embodiment.

FIG. 3 is an assembly view showing internal detail of this embodiment, including the venturi mixer thereof and associated tubing and connectors.

### DESCRIPTION OF A PREFERRED EMBODIMENT

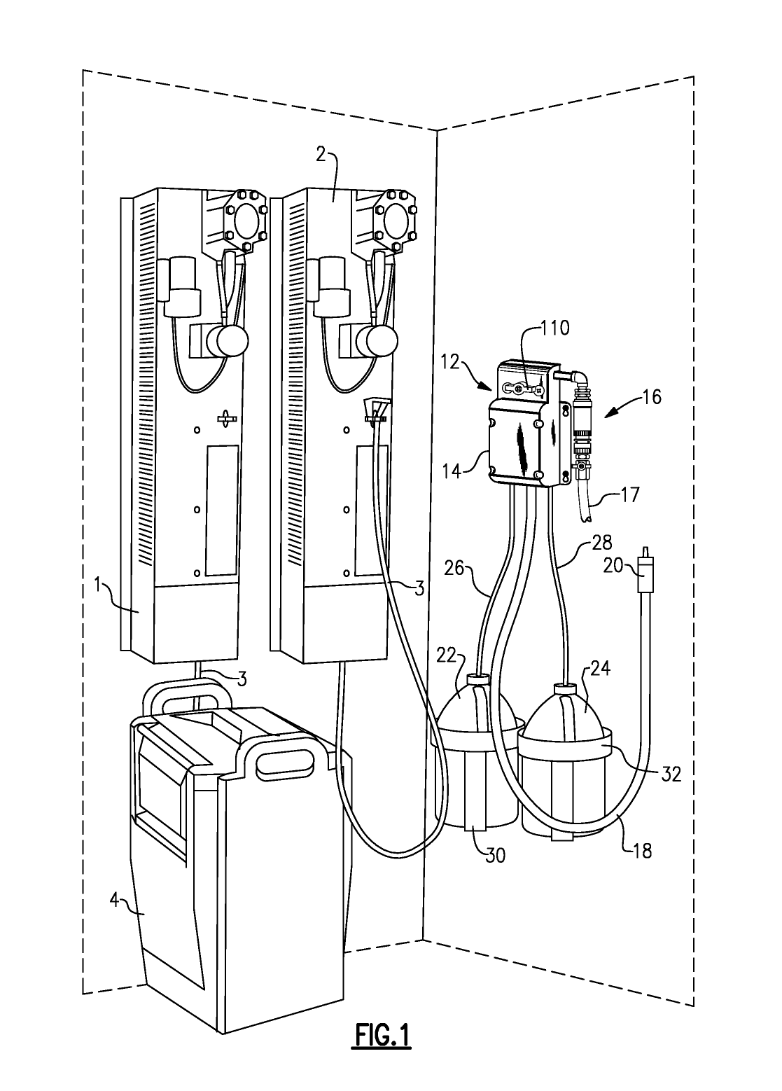

With reference to the Drawing, FIG. 1 shows a beverage preparation station of a kitchen or tea-making area of a restaurant or similar establishment including a first tea brewing machine 1 and a second tea brewing machine 2, e.g., for preparation of unsweetened tea concentrate and sweetened or flavored tea concentrate, respectively. These tea brewing machines 1, 2 shown here are the type of beverage concentrate preparation system as described in Wells Pub. No. US 2011/0008504 A1, although the cleaning and sanitation system of this invention could be employed favorably for routine use with many other types of beverage preparation system. Each of the tea brewing machines has a suction hose 3 that may be used for pumping concentrated brewed tea from a beverage container or reservoir 4.

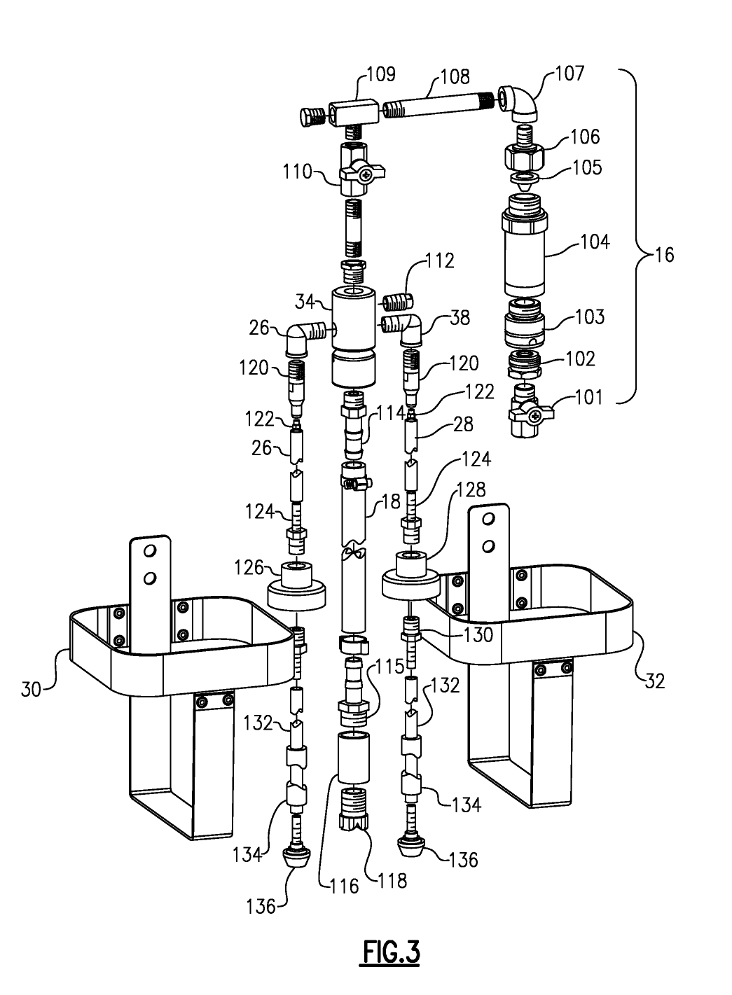

Mounted on the wall adjacent the two tea brewing machines is a wall-mounted cleaning and sanitizing system 10, here adapted for use in cleaning and sanitizing a tea line of the type mentioned and represented by the tea brewing machines 1 and 2. The system 10 includes a mixer-dispenser unit 12, which can be wall-mounted using four screws and anchors (if necessary). A venturi mixer 34 (shown schematically in FIG. 3) is situated beneath a cover 14 of the unit. A standard ¾ inch female connection 16 (here including a flow regulator) serves as water inlet and is connected to a water tube or water line 17. A half-inch clear outlet tube 18, typically a food-grade flexible plastic hose, carries the cleaning and sanitizing solution from the mixer-dispenser 12 and has a quick-connect/quick-disconnect connector 20 at its end. This coupler can be coupled to a cleaning fluid receptacle on the tea line or other beverage line, or may be connected with a wand or spray nozzle to be discussed later.

A gallon jug of sanitizer 22 and a gallon jug of activator 24 are connected through respective conduits or tubes 26 and 28 to inlets of the mixer dispenser. There are respective stainless-steel jug racks 30 and 32, which are wall-mounted just below the mixer-dispenser 12.

In this embodiment, the liquid sanitizer within the jug 22 is an aqueous solution of sodium chlorite, which is a non-toxic, non-hazardous chemical, and the liquid activator within the jug 24 is an aqueous solution of citric acid, which is another non-hazardous chemical. The flow of water through the mixer-dispenser 12 draws equal parts of the sanitizer and activator solutions through the conduit tubes 26 and 28. These ingredients mix and combine to form an aqueous solution of chlorine dioxide, which serves as the active chemical for cleaning and sanitizing the food equipment. This chlorine dioxide solution will destroy various bacteria and moulds while cleaning the equipment.

The mixer-dispenser works by venturi action, as explained with reference to FIG. 3. Water received via the water inlet connector 16 flows through a mixer body or venturi tube 34. The sanitizer and activator tubes 26 and 28 are received onto respective venturi nozzles which penetrate into the venturi tube 34. The venturi nozzles have associated controlled orifices that are adjusted to so as to meter the flow through the conduits or tubes 26, 28. The flow rate should be the same for each of the sanitizer and the activator. The sanitizer and activator solutions are formulated for flow at the equal rates into the venturi body of the mixer-dispenser unit. In this way, a chemical reaction problem is avoided if the employee installs the chemical jugs in the wrong racks by mistake.

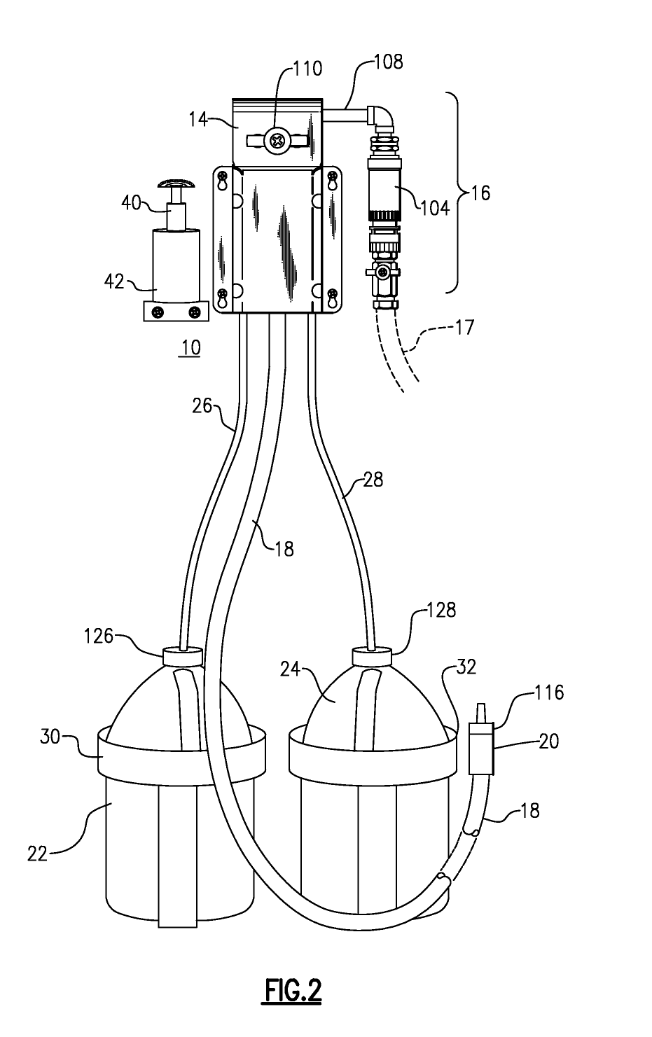

As also shown in FIG. 2, a spray nozzle 40 is shown held in a tubular holder or receptacle 42 at one side of the mixer-dispenser unit 12. This sprayer can attach onto the quick-connect quick-disconnect connector 20. A modified fan spray pattern, at about 1.5 gallons per minute, can be used for spray cleaning inside surfaces of the beverage concentrate receptacles, for example.

In the preferred embodiment, the unit produces a flow of chlorine dioxide solution at 50 ppm to 200 ppm, that can flow through the tea lines, and can also be used to spray on surfaces or into utensils and containers. The hose 18 can be used to fill containers, and also allows the solution to be pumped through the beverage preparation system.

In this embodiment, the jug racks are clearly marked for SANITIZER and for ACTIVATOR, for the benefit of employees. Also, these may be color-coded to match the colors of the plastic jugs 22 and 24.

Detail of the cleaning and sanitizing system are shown in the assembly view of FIG. 3.

Here, the female inlet connector 16 is formed of an (optional) inlet ball valve 101 with back-flow preventer, with a threaded adapter 102 that fits onto a primary backflow preventer 103. A flow regulator 104 is designed to maintain the water pressure at about 30 PSI. A filter screen 105, for coarse particulate screening, is seated between the backflow preventer 103 and a threaded adapter 106 that is coupled to a ninety-degree elbow fitting 107 which connects via a threaded pipe nipple 108 to one side of a tee fitting 109. The tee fitting then is mounted to a ball valve 110 which serves as the main shut off for the system, and which leads to the main venturi body 34. Venturi inlets, in the form of 90-degree bend elbow fittings 36 and 38 are mounted opposite one another within threaded penetrations in the venturi body 34, and a siphon breaker 112 is also mounted to the venturi body just above one of the venturi inlet fittings 36 or 38. A hose barb 114 is attached at the lower or discharge end of the venturi body 34, onto which the upper end of the hose 18 is fitted. A distal hose barb 115 is fitted into the other or distal end of the hose 18, and this holds a coupling 116, which may be used to attach to a cleaning fitting on either of the two tea brewing machines. The coupling may also be used for attaching to a sprayer, wand or other tool, and may be used for spraying and cleaning the internal surfaces of the tea concentrate reservoir 4.

For each of the elbow fittings 36, 38 there is connector hardware to link the same with the respective suction hoses 26, 28 and jugs 22, 24. Here, for each elbow fitting there is a check valve 120 to which is attached a metering tip 122 to regulate the flow of activator or sanitizer solution, respectively, and these are fitted to upper ends of the respective suction hoses 26, 28. The suction hoses then each have a hose barb 124 fitted into a distal end, with the hose barb 124 being also fitted into a threaded penetration in a respective lid 126 or 128 or cap for the sanitizer jug or the activator jug. At the lower or inner side of the cap or lid 126, 128 is another hose barb 130 to which a short segment of suction tubing 132 is fitted. This segment 132 may be about six inches in length, so as to reach the bottom of the respective jug. A tube weight 134 is present at the lower end of the tubing 132, with a suction strainer 136 fitted into the lower end thereof.

Dual test strips are provided to allow the employees to check the sanitizer and activator solution strength.

In the preferred embodiment, the intake water is supplied to the inlet connector at an elevated temperature of up to about 160° F., with a pressure between about 30 and 100 psi and a flow rate of up to about 3 GPM. The supply pipe 17 may be ½ inch pipe.

In operation, it is recommended that the user not modify the outlet hose diameter or length, and that no valve be installed on the outlet hose. The ball valve 110, whose handle is available outside the front of the cover 14, should be used to turn the flow of the water and chemicals on and off. The user should always wear protective clothing, including gloves and eye protection, when using the sanitizing system, and the discharge hose should always be held away from persons and away from electrical equipment and outlets. Chemicals other than those recommended should be avoided for use as the sanitizer and activator. When installing the unit, the installer should ensure that the metering tips and tubes are all properly installed before mounting the mixer-dispenser unit and before connecting with the water source.

The mixer-dispenser unit 12 should be mounted a suitable height above the jug racks 30 and 32, favorably about eighteen to twenty-four inches.

The connector 20 (FIG. 1) can be attached directly to a cleaning reservoir or empty tea concentrate reservoir on the tea line, e.g., on machine 1 or 2, and should be adequately tightened. The outlet hose 3 of the tea brewing machine 1 or 2 should be secured in a suitable sink or other drain, and then the valve 110 opened to permit the flow of cleaning solution to clean and sanitize the line. Where the solution is to be filled into a container, the discharge tube 18 should be held in the container to be filled and not released, and then the ball valve 110 should be completely opened to fill the container. Then the solution can be used to clean and sanitized exterior surfaces. The spray nozzle fitting can be used for cleaning the inside surfaces of the tea concentrate reservoir 4.

While sodium chlorite and citric acid are employed here as active ingredients for the sanitizer and activator solutions, it should be understood that other safe chemicals could be used to combine and form an effective cleaning and sanitizing solution, suitable for use in food and beverage preparation equipment.

For removing stubborn problems, a separate cleaning can be carried out using a powdered cleanser (buffered cleaner) to run through the tea station, followed by a rinse using the sanitizer and activator (chlorite and citric acid solutions), as described above. This cleaning can employ the cleaning and sanitizing system, in which the activator jug combines the activator with a buffered cleaner for occasional use, e.g., weekly use. Also, a portable system may be used favorably with small tea station systems, which may be formed of a portable stand with brackets for two smaller (quart-size) activator and sanitizer jugs, and with the mixer and hoses mounted thereon generally as described earlier. This can be used by the proprietor, e.g., at shut down in the evening, or at a less busy time during the day.

The invention has been described in terms of a preferred embodiment, but the principles of this invention may apply to many other possible embodiments without departing from the scope and spirit of this invention, as defined in the appended claims.

I claim:

1. System for cleaning and sanitizing food and beverage dispensing equipment, comprising
a) a source of a sanitizer aqueous solution;
b) a source of an activator aqueous solution; and
c) mixer dispenser unit having conduits leading from each of said sources, and including a water inlet to receive a flow of input water, a mixer portion for adding said sanitizer aqueous solution and said activator aqueous solution to said flow of water, where the sanitizer and activator combine to form a cleaning and sanitizing solution; and an outlet conduit carrying said cleaning and sanitizing solution to said food and beverage dispensing equipment.

2. The system of claim 1 wherein said sanitizer and said activator solutions are non-hazardous, safe chemicals.

3. The system of claim 2 wherein said sanitizer aqueous solution includes sodium chlorite in water.

4. The system of claim 2 wherein said activator solution includes citric acid dissolved in water.

5. The system of claim 1 wherein said mixer portion includes a mixer body through with said input water flows, and a pair of venturi members to which the conduits that lead from the sources of the sanitizer aqueous solution and the activator aqueous solution are respectively connected, and the mixer portion being adapted to employ a venturi effect to pull the sanitizer solution and the activator solution through said conduits and into said flow of water.

6. The system of claim 5 wherein said mixer portion is positioned so that said flow of water if downward from said inlet to said outlet conduit.

7. The system of claim 5 wherein said venturi members are positioned directly opposite one another on said mixer body.

8. The system of claim 1 wherein said mixer dispenser unit includes a valve positioned between said water inlet and said mixer portion.

9. The system of claim 1 wherein said sanitizer aqueous solution and said activator aqueous solution are prepared in respective concentrations such that equal parts of said sanitizer aqueous solution and said activator aqueous solutions are mixed with said flow of water to comprise the cleaning and sanitizing solution.

10. The system of claim 1 wherein said sources of the sanitizer aqueous solution and of the activator aqueous solution each comprise a reservoir, and said system further comprises a pair of support brackets adapted for holding the reservoir for said sanitizer aqueous solution and the reservoir for said activator aqueous solution, respectively.

11. The system of claim 10 wherein said reservoirs each include a jug formed of a synthetic resin material, and having a cap removably fitted onto a neck of the jug, and wherein each said conduits leading from the sources of the activator aqueous solution and the sanitizer aqueous solution each include a flexible suction tube passing through a penetration in the cap of a respective one of said jugs.

12. The system of claim 1 wherein said mixer dispenser unit includes a bracket adapted to permit the mixer dispenser unit to be mounted on a vertical surface, and comprising a cover removably affixed over said mixer portion thereof.

13. The system of claim 12 wherein said sources of said sanitizer aqueous solution and of said activator aqueous solution include jugs containing said respective solutions, and further comprising a pair of brackets mounted below said mixer dispenser unit, and each adapted to hold one of said jugs.

14. The system of claim 1 wherein said outlet conduit comprises an elongated tube of a flexible synthetic resin.

15. The system of claim 14 wherein said outlet conduit further comprises an end connector adapted to be removably fitted onto a mating fitting on an associated beverage preparation and dispensing system, and to be fitted to a spray head therefor.

16. A method of cleaning and sanitizing food and/or beverage dispensing equipment comprising:
providing a flow of water through a conduit to a venturi body, said venturi body having a pair of venturi nozzles therein;
providing a first container of a sanitizer aqueous solution, with a suction hose connecting the first container to one of said venturi nozzles;
providing a second container of an activator aqueous solution, with a suction hose connecting the second container to a second one of the venturi nozzles;
said venturi nozzles drawing in said sanitizer aqueous solution and said activator aqueous solution into the flow of water within said venturi body;
wherein an outlet hose being coupled to an outlet of said venturi body conducts a flow of a cleaning and sanitizing solution composed of said flow of water and a combination of said sanitizer and activator aqueous solutions; and
discharging the cleaning and sanitizing solution from said outlet hose into or onto said food and/or beverage dispensing equipment.

17. The method of claim 16 wherein said sanitizer aqueous solution includes sodium chlorite, and said activator solution includes a weak acid.

18. The method of claim 16 wherein said flow of water is provided at a rate of 1.5 to 3 gallons per minute.

19. The method of claim 16 wherein said sanitizer aqueous solution and said activator aqueous solution are prepared in respective concentrations such that equal parts of said sanitizer aqueous solution and said activator aqueous solutions are mixed with said flow of water to comprise the cleaning and sanitizing solution; and with said venturi nozzles injecting said aqueous solutions at equal amounts into said flow of water through said venturi body.
